(19) United States
(12) Patent Application Publication
(10) Pub. No.: US 2008/0273769 A1
(43) Pub. Date: Nov. 6, 2008

(54) PRINT MATCHING METHOD AND SYSTEM USING DIRECTION IMAGES

(75) Inventors: PETER Z. LO, LAKE FOREST, CA (US); GUIPING YU, HAIDIAN DISTRICT (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/742,820

(22) Filed: May 1, 2007

(51) Int. Cl. G06K 9/34

(52) U.S. Cl. 382/125; 382/178

(57) ABSTRACT

A system includes an interface receiving a search print record including a first direction image of a search print and a file print record including a second direction image of a file print, and a processing device. The processing device performs a method and a computer-readable storage medium stores code for programming a computer to perform the method, which includes: aligning the first and second direction images to identify an overlapping and a non-overlapping area; comparing block direction between the first and second direction images within the overlapping area; performing a rationality analysis on the aligned direction images to at least determine whether one of the direction images and the non-overlapping area of the other direction image are from a different finger; and generating a similarity score based on the block direction comparison and the rationality analysis, which indicates a measure of similarity between the search and file prints.

### CROSS-REFERENCE TO RELATED APPLICATIONS

The present application is related to the following U.S. applications commonly owned together with this application by Motorola, Inc.:

Ser. No. 11/456,622, filed Jul. 11, 2006, titled “Method and Apparatus for Adaptive Hierarchical Processing of Print Images” by Lo, et al. (attorney docket no. CM09426G); and

Ser. No. 11/554,720, filed Oct. 31, 2006, titled “Print Matching Method and Apparatus Using Pseudo-Ridges by Lo, et al. (attorney docket no. CM09327G).

### TECHNICAL FIELD

The technical field relates generally to print identification systems and more particularly to a matching method that compares prints using their direction images.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, are extracted. The personal information and the extracted features are then used to form a file record that is saved into a database for subsequent print identification. Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Many solutions have been proposed to improve the accuracy of similarity scores and to reduce the workload of manual examiners. These methods include: designing improved fingerprint scanners to obtain better quality print images; improving feature extraction algorithms to obtain better matching features or different features with more discriminating power; and designing different types of matching algorithms from pattern based matching to minutiae and texture based matching, to determine a level of similarity between two prints.

Current matching algorithms typically fall into four categories. The first is classification based filtering and matching, wherein a fingerprint can be classified into one of N types based on ridge direction flow (from a direction image). The class of the fingerprint (as global information) is used for filtering and clustering. A shortcoming of this method is that the class information is too coarse to be used for fingerprint matching and recognition. However, pseudo-ridge tracing based on direction image has been used to verify the print classification result, and because the pseudo-ridge contains detailed global structural information, it has been proposed for use in print matching.

The second method is minutiae based matching, wherein two prints are aligned and compared based on their respective minutiae points. A shortcoming of this method is that one area in the first print may be aligned with a different area in the second print due to distortion or noises, which may generate unreliable results. The third method is mated minutiae based secondary matching, wherein the local ridge structure along the mated minutiae is used to compare two prints, after minutiae matching is performed on the two prints. This approach can provide information as to whether or not the two compared areas are matched in ridge structure, but it cannot address the problem where mated minutiae are incorrectly identified during minutiae matching. Moreover, this method requires using a thin image or a gray scale image. Finally, the fourth method is Filter bank/Finger Code matching, which uses an average absolute deviation of a filtered image from a tessellated region to compare two prints. However, a shortcoming of this method is that it suffers badly when implemented on low quality images.

Thus, there exists a need for print a matching method and system, which addresses at least some of the shortcomings of past and present print matching techniques and mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a block diagram of an AFIS implementing some embodiments.

FIG. 2 illustrates a direction image of a fingerprint image.

FIG. 3 is a flow diagram illustrating a method for print image comparison in accordance with some embodiments.

FIG. 4 illustrates two aligned direction images processed using some embodiments.

FIG. 5 illustrates distribution curves for a print identification system prior to implementing some embodiments.

FIG. 6 illustrates distribution curves for a print identification system after implementing some embodiments.

FIG. 7 illustrates patterns detected and used in implementing some embodiments.

FIG. 8 illustrates methods using non-overlapping areas of direction images in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a system, method and computer-readable storage medium for print matching using direction image is described. Upon receiving into a print matching system a search print record comprising at least a first direction image of a search print and a file print record comprising at least a second direction image of a file print, the first and second direction images are aligned to identify an overlapping and a non-overlapping area of the aligned direction images, and a two-part analysis is performed on the aligned direction images.

A first part of the two-part analysis includes comparing block direction between the first and second direction images within the overlapping area. The hypostasis of the overlapping area block direction comparison is that direction images between two matching prints are the same. However, direction images between two non-matching prints are typically not the same. Therefore, in an embodiment, the overlapping area block direction comparison correlates the directions of the two direction images within the overlapping area to create a correlation score.

In other print matching methods, non-overlapping area direction information is usually discarded. However, in accordance with some embodiments, a second part of the two-part analysis includes performing a rationality analysis on the aligned direction images to determine whether a whole direction image and the non-overlapping area from the other direction image are from a different finger. The hypostasis of the rationality analysis is that any part of a direction image from a same finger is rational to the whole fingerprint image. Therefore, the rationality analysis analyzes the relationship of direction in the non-overlapping area of one direction image to the other whole direction image. From such an analysis, it can be determined whether or not the whole direction image and the non-overlapping area of the other direction image are from the same finger. A score is further generated from this analysis.

A similarity score is then determined based on the block direction comparison and the rationality analysis to measure similarity between the search and file prints. In an embodiment, since the quality of a fingerprint affects the direction calculation, the score calculation output from both parts of the two-part analysis are weighted according to quality factors for each block of the direction images. Finally, the scores can be fused with a minutiae matcher score to reduce the false accept rate.

Therefore, in accordance with embodiments, false positives (and thereby the false accept rate) can be reduced in the print matching/verification. Those skilled in the art will realize that the above recognized advantages and other advantages described herein are merely illustrative and are not meant to be a complete rendering of all of the advantages of the various embodiments.

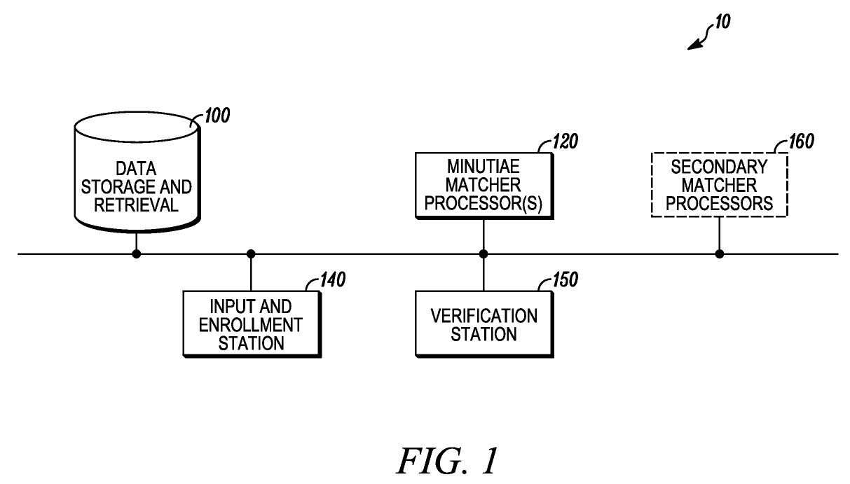

Referring now to the drawings, and in particular FIG. 1, a logical block diagram of an illustrative fingerprint matching system implementing some embodiments is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identify one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to herein as respondent file print images).

Before describing system 100 in detail, it will be useful to define terms that are used herein.

A print is a pattern of friction ridges (also referred to herein as “ridges”), which are raised portions of skin, and valleys between the ridges on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range. An example of a range of gray-level values is 0 to 255.

Image binarization is the process of converting a gray-scale image into a “binary” or a black and white image. A thin image is a binary image that is one pixel wide. A wide binary image is a binary image that preserves at least the shape and width of ridges and the shape of pores.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeably with the term score) that identifies or indicates similarity of a file print to a search print based on one or more given parameters.

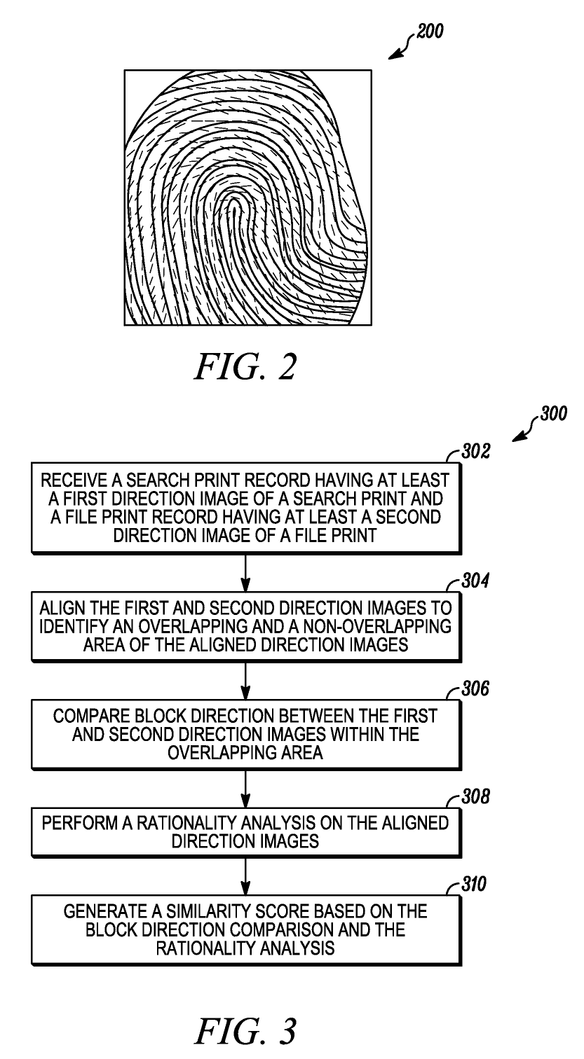

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. A number of methods exist to determine direction and smooth direction images. FIG. 2 illustrates a direction image 200 of a fingerprint.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

Level-three features are defined for fingerprint images, for example, relative to level-one and level-two features. Level-one features are the features of the macro-scale, including cores/deltas. Level-two features are the features in more detail, including minutiae location, angles, ridge length and ridge count. Level-three features are of the micro-scale, including pores, ridge shape, ridge gray level distribution and incipient ridges. In comparison to level-one and level-two features which are widely available in current fingerprint images, level-three features are most reliably seen in high resolution, e.g., ≧1000 ppi (pixels per inch) images.

Aligning two images (e.g., direction images or print images) includes positioning, e.g., by rotating and translating, the two images in relation to one another. Aligning can be done based on mated minutiae, wherein the two images are aligned such that there are a maximum number of mated minutiae detected between the images. Other alignment methods may be used in addition to or alternatively to mated minutiae alignment, such as alignment based on cores and/or deltas, which is well known in the art, and therefore not discussed in detail here for the sake of brevity.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160. Embodiments may be implemented in one or more of the verification station 150 and the secondary matcher processor(s) 160, which in turn can be implemented using one or more suitable processing devices, examples of which are listed below.

Input and enrollment station 140 is used to capture fingerprint images to extract the relevant features (minutiae, cores, deltas, binary image, ridge features, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

Turning now to FIG. 3, a flow diagram illustrating a method of comparing prints using direction images in accordance with some embodiments is shown and generally indicated at 300. In this illustrative implementation, method 300 is described in terms of a fingerprint identification process (such as one implemented in the AFIS shown in FIG. 1) for ease of illustration. However, it is appreciated that the method may be similarly implemented in biometric image identification for other types of prints such as, for instance, palm prints or toe prints without loss of generality, which are also contemplated within the meaning of the terms “print” and “fingerprint” as used in the various teachings described herein. Thus, all types of prints and images are contemplated within the meaning of the terms “print” and “fingerprint” as used in the various teachings described herein.

In general, method 300 comprises: receiving (302) a search print record comprising at least a first direction image of a search print and a file print record comprising at least a second direction image of a file print; aligning (304) the first and second direction images to identify an overlapping and a non-overlapping area of the aligned direction images; comparing (306) block direction between the first and second direction images within the overlapping area; performing (308) a rationality analysis on the aligned direction images to at least determine whether one of the direction images and the non-overlapping area comprising the other direction image are from a different finger; and generating (310) a similarity score based on the block direction comparison and the rationality analysis, which indicates a measure of similarity between the search and file prints.

Illustrative details for implementing method 300 will next be described. At 302, the search and file print records are received using any suitable interface within or into the system. For example, the search print record can be obtained from the input and enrollment station 140. In an embodiment, the file record is a candidate record in a match report generated by minutiae matcher processor(s) 120. In addition to the direction images corresponding to the search and file prints, one or more other features may have been extracted during the enrollment stage and included in the search and file records. These features include, but are not limited to, core, delta, and classification type. Classification type may be, for example, whorl, left loop, right loop, tented arch, and plain arch. Moreover, image quality at individual pixel locations or at blocks of pixels within the direction image can be determined using any suitable means, to facilitate implementations of various embodiments.

These features may be stored as a template with a standard exchangeable format. Moreover, since storage of a direction image in a regular format can use more storage space than is desirable for some implementations, the direction images may alternatively be quantized into a smaller range of values and the direction images may further be compressed using any suitable image or data compression technique to minimize storage requirements. For example, in an embodiment, the number of directions in a direction image may be quantized into M and the dimensionality of the direction image reduced to R×C from Rn×Cn for computational efficiency, wherein a block (of pixels) represents (Rn×Cn/R×C) pixels.

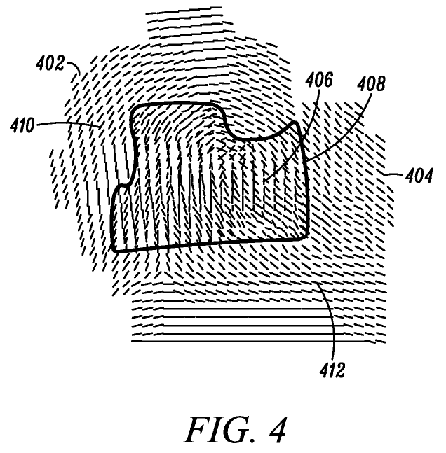

At 304, the direction images of the search and file prints are aligned to identify overlapping and non-overlapping areas of the aligned direction images. As stated above, the direction images can be aligned based on at least one of mated minutiae, cores and deltas extracted from the respective print images. FIG. 4 illustrates alignment of a search print image 402 and file print image 404. Within the aligned direction images can be identified an overlapping area 406 within a boundary 408 of the overlapping area. The overlapping area comprises intersecting areas of direction images 402 and 404. Outside of the boundary 408 is the non-overlapping area of the aligned images. The non-overlapping area in this case comprises both an area 410 from the search direction image and an area 412 from the print direction image.

At 306, comparing block direction between the first and second direction images can, for example, include determining one or more of the following: at least one parameter that is calculated based on a first number of blocks within the overlapping area each having a quality that exceeds a quality threshold (Qₜ) and a direction difference that exceeds a direction difference threshold (Dₜ); at least one parameter that is calculated based on a second number of blocks at a boundary of the overlapping area each having a quality that exceeds a quality threshold (Qₜ) and a direction difference that exceeds a direction difference threshold (Dₜ); and at least one measure of direction difference within the overlapping area. These parameters and measures individually and in combination provide for a measure of similarity between the search and file print images.

In one embodiment, the at least one parameter that is calculated based on the first number of blocks within the overlapping area each having a quality that exceeds a quality threshold and a direction difference that exceeds a direction difference threshold comprises f1=Nq/Nd and f2=Nq/N, wherein N is a total number of blocks within the overlapping area, Nd is a portion of the N blocks having a quality that exceeds the quality threshold, and Nq is a portion of the Nd blocks having a direction difference that exceeds the direction difference threshold. Features f1 and f2 provide a similarity measure between the search and file direction images in the overlapping area based on a discreet representation of the direction difference in the overlapping area.

The thresholds Qₜ and Dₜ can be selected based on factors including, but not limited to, the quantization scale used for the direction images, a quality level standard for the system, etc. For example, in one implementation Qₜ can be set to 75 in (e.g., on a scale of 0 in to 100 in, with 0 in being the lowest quality and 100 in being the highest quality), which is a quality standard designated by the National Institute of Standards & Technology (NIST), and Dₜ can be set to 30 degrees. Accordingly, where the search and file prints are mated prints (that come from the same finger), after alignment, the value of Nq should be close to zero, especially for high quality (over the quality threshold) mated areas. Whereas, this is likely not the case if the prints are non-matching.

In an embodiment, the at least one measure of direction difference within the overlapping area comprises f3=Σ{wi(qi)abs{Dsi−Dfi}, i=0 to N}/N and f4=(Σ{di−f3}²)/N, wherein Dsi−Dfi is the direction difference at block i, wi(qi) is a weighted function of a quality measure at block i, and di=wi(qi)abs{Dsi−Dfi}. The weighted function can be designed to give the direction difference in a high quality area more weight than the direction difference in a low quality area. The feature f3 is the weighted absolute average direction differences between the search and file direction images, and is another representation of the similarity between prints in the overlapping area.

If the search and the file prints are mated, after alignment, the value of f3 should also be close to 0. Moreover, feature f3 provides a continuous representation of the direction difference in the overlapping area. The feature f4 is the variance of the direction difference in the overlapping area, and is a representation of direction similarity between the search and file print direction images in the overlapping area. Feature f4 can, for instance, be used to distinguish the cases that have similar mean with different variances.

In an embodiment, the at least one parameter that is calculated based on the second number of blocks at a boundary of the overlapping area each having a quality that exceeds the quality threshold and a direction difference that exceeds the direction difference threshold comprises f5=Nqb/Ndb and f6=Nqb/Nb, wherein Nb is a total number of blocks at the boundary of the overlapping area, Ndb is a portion of the Nb blocks having a quality that exceeds the quality threshold, and Nqb is a portion of the Ndb blocks having a direction difference that exceeds the direction difference threshold.

Similar to determining f1 and f2, the thresholds Qₜ and Dₜ can be selected based on factors including, but not limited to, the quantization scale used for the direction images, a quality level standard for the system, etc. For example, in one implementation Qₜ can be set to 75 in (on a scale of 0 in to 100 in), which is a quality standard designated by NIST, and Dₜ can be set to 30 degrees. Accordingly, where the search and file prints are mated prints (that come from the same finger), after alignment, the value of Nqb should be close to zero, especially for high quality (over the quality threshold) mated areas. Whereas, this is likely not the case if the prints are non-matching.

Features f1, f2, f3, f4, f5 and f6 can be combined into a feature vector that represents a similarity measure between the search and file prints. However, based on empirical data, it can be shown that some non-matching prints have similar direction structure, e.g., based on having a similar feature vector (f1, f2, f3, f4, f5, f6). Therefore, it cannot be conclusively determined from the feature vector whether the search and file prints are from the same finger, even though they have matching direction images. However, it can be determined with a high degree of certainty that the search and file prints are non-matching (not from the same finger) if their feature vectors (f1, f2, f3, f4, f5, f6) indicate that their respective direction images are different, especially where the quality of both direction images in the overlapping area are high. With this in mind, a decision function f( ) can be designed based on the feature vectors (f1, f2, f3, f4, f5, f6) to reduce a false acceptance rate of a fingerprint identification system.

False acceptance rate is defined based on distribution curves generated using a given print identification system and a system threshold t used for determining whether two prints belong to the same finger. The threshold t can be selected based on a level of security desired for the system, wherein more secure systems have a higher system threshold. More particularly, pairs of fingerprints generating scores higher than or equal to t are inferred as matching pairs (i.e., belonging to the same finger), and pairs of fingerprints generating scores lower than t are inferred as non-matching pairs (i.e., belonging to different fingers). A typical biometric verification system commits two types of errors: mistaking biometric measurements from two different fingers to be from the same finger (called false match or false acceptance rate (FAR)), and mistaking two biometric measurements from the same finger to be from two different fingers (called false non-match or false rejection rate (FRR)).

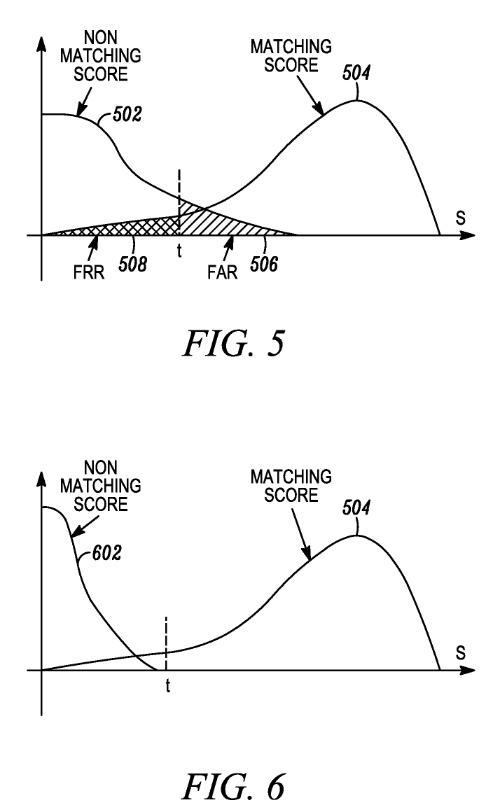

FIG. 5 illustrates two distribution curves 502 and 504 and a selected biometric identification system threshold t upon which a FAR 506 for the system is determined. Curve 502 is a non-matching minutiae matcher score (S) distribution curve for the biometric identification system, which can be generated from a number of fingerprint pairs from different fingers. Curve 504 is a matching score distribution curve, which can be generated from a number of fingerprint pairs from the same finger. The FAR 506 represents the percentage of false match pairs whose matching score is greater than or equal to t. A FRR 508 represents those true match fingerprint pairs that have a matching score that is less than t.

As can be seen from curves 502 and 504, there is a strict tradeoff between FAR and FRR in a biometric identification system and both are a function of the system threshold t. Thus, normally if t is decreased to make the system more tolerant with respect to input variance and noise, then the FAR increase. Vice versa, if t is increased to make the system more secure, then the FRR increases. However, using embodiments in accordance with the teachings herein, the FAR can be decreased by reshaping the non-matching distribution curve 502 through the design of the function f( ) for feature vector (f1, f2, f3, f4, f5, f6).

Assuming S is a minutiae matcher score corresponding to the search and file print being compared, a new score Sn can be calculated according to the formula: Sn=S−f(f1,f2,f3,f4,f5,f6). By selecting a correct decision function, the shape of the non-matching score distribution curve can be shifted toward to the right side so that the overlap area between the matching and non-matching curves will be minimized. There are several ways to design the decision f( ). The simple's way is to set f( ) as a linear function; i.e., f(f1, f2, f3, f4, f5, f6)=w1f1+w2f2+w3f3+w4f4 . . . +w6f6+w, where w, w1, w2, w3, w4, w5 and w6 are weight parameters. Then, the designing of the decision function becomes selecting a set of the weight parameters. Any classical method such as linear regress can be used to select the weight parameters.

Another method is to view the problem as a classification design problem; that is to assume f( ) will map into finite classes that correspond to a set of scores. An example of some finite classes are (no difference, small difference, medium difference, big difference) and the corresponding scores are (0, Highest non-matching score/4, Highest non-matching score/3, Highest non-matching score). In this way, the finding of f( ) becomes a classifier design problem. Any tradition method of neural networks can be used to map the score and feature relationship to achieve an optimal distribution curve. FIG. 6 shows the minutiae match score distribution curves after applying the f(f1, f2, f3, f4, f5, f6). As can be seen, matching score distribution curve 504 remains the same. But the non-matching distribution curve (labeled 602) is shifted to the right, thereby minimizing the FAR without changing the system threshold t. In this particular case, there will still be some true mated pairs that will be detected as non-matching pairs. However, the system is designed such that no non-matching pairs are detected as mated pairs.

As indicated above, a second aspect of the teachings herein is this use of the non-overlapping area of the aligned direction images to assist in the verification process, whereas, normally such information is discarded. This is done by performing a rationality analysis on the aligned direction images that looks at a whole direction image and the non-overlapping area of the other direction image to determine whether they are from a different finger. Since the non-overlapping area does not have a corresponding area of the other print, traditional methods to directly compare or correlate two areas to get a difference cannot be used. However, using embodiments herein it can be determined whether or not each non-overlapping area 410, 412 is part of a whole fingerprint image of a finger; or in other words to determine whether the extra part, the non-overlapping part, is from a different part of a different finger or is from the same finger, but the area was not captured in that impression of the print.

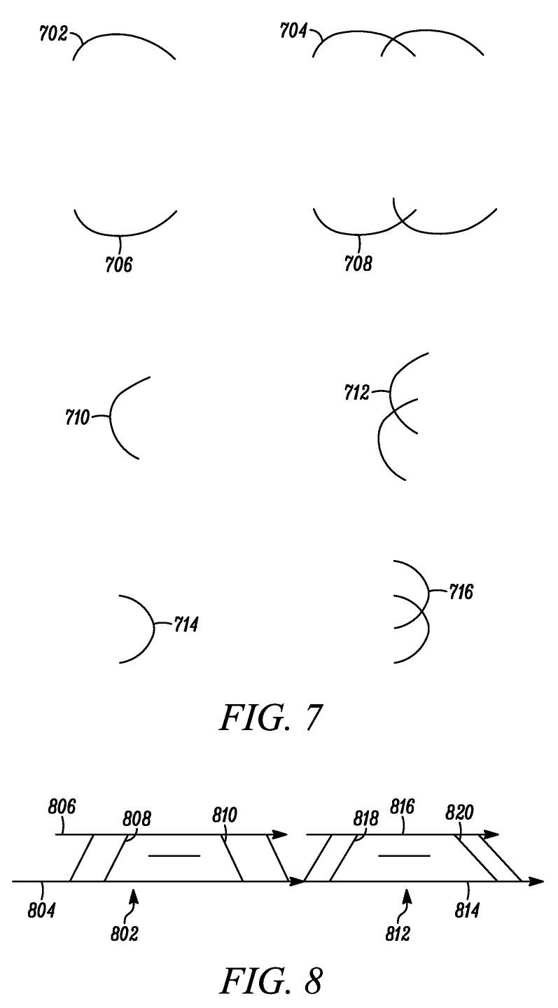

The shape of natural fingerprints may consist of the following four patterns: convex upward, concave, convex leftward and convex rightward (see FIG. 7). Be detecting for these shapes within the aligned direction images in a manner described below, the fingerprint identification system can determine whether two direction images are from the same finger or from two different fingers. It is known that: the shape of a top portion of a fingerprint may consist of one convex upward shape 702 in a zone of horizontal rows across the aligned direction images, but not two convex upward patterns 704 appearing together in the same zone of horizontal rows; the shape of a bottom portion of a fingerprint may consist of one concave shape 706 in a zone of horizontal rows across the aligned direction images, but not two concave patterns 708 appearing together in the same zone of horizontal rows; the shape of a left side portion of a fingerprint may consist of one convex leftward shape 710 in a zone of vertical columns down the aligned direction images, but not two convex leftward patterns 712 appearing together in the same zone of vertical columns; and the shape of a right side portion of a fingerprint may consist of one convex rightward shape 714 in a zone of vertical columns down the aligned direction images, but not two convex rightward patterns 716 appearing together in the same zone of vertical columns.

Thus, it is irrational to find two of the same patterns in the same fingerprint in the same zone of horizontal rows or the same zone of vertical columns in the aligned images, wherein each zone analyzed extends across or down and includes blocks from both a whole direction image and the non-overlapping portion of the other direction image. Moreover, a zone of horizontal rows can be one horizontal row within the aligned direction images or a plurality of adjacent rows depending on the implementation used for detecting the patterns. Similarly, a zone of vertical columns can be one column within the aligned direction images or a plurality of adjacent columns depending on the implementation used for detecting the patterns.

In general, the rationality analysis in accordance with embodiments is used to detect these patterns and may comprise at least one of: at a zone of horizontal rows across the aligned direction images, detecting at least one of whether a convex upward pattern exists in both the whole direction image and in the non-overlapping area comprising the other direction image, and detecting whether a concave pattern exists in both the whole direction image and in the non-overlapping area comprising the other direction image; and at a zone of vertical columns down the aligned direction images, detecting at least one of whether a convex leftward pattern exists in both the whole direction image and in the non-overlapping area comprising the other direction image, and detecting whether a convex rightward pattern exists in both the whole direction image and in the non-overlapping area comprising the other direction image.

The rationality analysis used to detect the four patterns can be performed using one or both of a scanning method and a tracing method. In general, the scanning method comprises quantizing direction values into at least a / direction and a \ direction, and scanning rows and columns in the aligned direction images to detect the existence of the convex upward, concave, convex leftward and convex rightward patterns by detecting at least one of whether there is a direction change from the / direction to the \ direction and whether there is a direction change from the \ direction to the / direction. In general, the tracing method comprises identifying traced direction pseudo-ridge crossings within at least one of the zone of horizontal rows and the zone of vertical columns to detect the existence of the convex upward, concave, convex leftward and convex rightward patterns. A detailed illustrative implementation of both the scanning method and the tracing method follows.

Regarding the illustrative implementation of the scanning method, before scanning the aligned direction images, the block direction values of the aligned direction images are quantized into four directions, i.e., /, -, \ and |, for a fast check and easier detection. To detect the convex upward pattern or the concave pattern, the quantized values of each row of an aligned whole left direction image (e.g., 402) are scanned from left to right to determine whether any row or zone of rows contains a convex upward pattern as represented by a direction change from the / direction to the \ direction or a concave pattern as represented by a direction change from the \ direction to the / direction.

As an illustration, FIG. 8 shows a portion 802 of direction image 402 being scanned from left to right at a row (or zone of rows) illustrated as being located between arrowed lines 804 and 806. In this illustration, a direction change from the / direction (e.g., 808) to the \ direction (e.g., 810) represents the detection of the existence of a convex upward pattern at that row (or zone of rows) in the direction image 402. Upon detection of the convex upward pattern in the left direction image 402, the non-overlapping area 412 of the right direction image 404 is scanned at the same row (or zone of rows) to determine whether a convex upward pattern also exists in this non-overlapping area.

Turning again to FIG. 8, once the convex upward pattern is detected in portion 802 of direction image 402, a portion 812 in the non-overlapping area of direction image 404 is scanned from left to right at the same row (or zone of rows) that was scanned in portion 802 of direction image 402. The same row (or zone of rows) in the non-overlapping area is illustrated as being located between arrowed lines 814 and 816. In this illustration, a direction change from the / direction (e.g., 818) to the \ direction (e.g., 820) represents the detection of the existence of a convex upward pattern at that same row (or zone of rows) in the direction image 404. In this particular example, the detection of the two convex upward patterns at the same row (or zone of rows) in both the whole direction image 402 and the non-overlapping area 412 of the direction image 404 indicates that the two direction images are from different fingers.

Similarly, to detect the convex leftward pattern or the convex rightward pattern, the quantized values of each column of an aligned whole left direction image (e.g., 402) are scanned from top to bottom to determine whether any column or zone of columns contains a convex rightward pattern as represented by a direction change from the / direction to the \ direction or a convex leftward pattern as represented by a direction change from the \ direction to the / direction. Those of ordinary skill in the art will also realize that the right image may be taken to be the whole image and the non-overlapping portion come from the left image, and that the scanning can be done from right to left and from bottom to top without loss of generality.

Regarding the illustrative implementation of the tracing method, as with the scanning method, direction pseudo-ridge tracing can be performed from the left image 402 of left side to check the horizontal rows to determine whether there exists a traced ridge that appears as a convex upward pattern or a concave pattern in any zone of horizontal rows. The traced direction pseudo-ridge is a continuous tracing of direction field points, where for each point on the pseudo-ridge, the tracing is performed in the way that the next pseudo-ridge point is always the non-traced point with smallest direction change with respect to the current point or the several previous points.

If a traced convex upward pattern (or traced concave pattern) is detected in a zone of the horizontal rows in the whole direction image 402, the same zone of horizontal rows are traced in the non-overlapping area of the right direction image 404 to determine whether a convex upward pattern (or concave pattern) also exists in the non-overlapping area. If the convex upward (or concave) traced pattern is detected at the same zone of rows in both the whole direction image 402 and the non-overlapping area in the other direction image 404, especially in a high quality area, there is a high likelihood that the two direction images come from a different finger. Similarly, the tracing can be performed on the vertical columns from top to bottom to determine whether both the whole direction image and the non-overlapping area in the other image contain a traced convex leftward (or traced convex rightward) pattern within the same zone of vertical columns, thereby, indicating that the two direction images came from different fingers.

As stated earlier, a similarity score can be generated that indicates a measure of similarity between the search and file prints, and the similarity score can be combined with a minutiae matching score output from the minutiae matching process and resulting from comparing minutiae from the file print with minutiae from the search print. In the illustrative embodiment described above, a minutiae matching score S corresponding to the search and file prints was modified by f(f1, f2, f3, f4, f5, f6) from the direction comparison within the overlapping area to generate a modified score Sn. Sn can be further modified by a score from the rationality analysis. For example, based on the number times the corresponding patterns are detected, a negative score Si can be added to the previous calculated score Sn, e.g., So=Sn−Si, to generate a final score So. The scale of the score Si may be a function of quality and times detected, i.e., the higher the quality is, the larger the value of Si will be. Score So can be further fused or combined with one or more scores from secondary matchers comprising the print verification system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for print matching using direction images described herein. The non-processor circuits may include, but are not limited to, a radio receiver, a radio transmitter, signal drivers, clock circuits, power source circuits, and user input devices. As such, these functions may be interpreted as steps of a method to perform the print matching using direction images described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processing device) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving a search print record comprising at least a first direction image of a search print and a file print record comprising at least a second direction image of a file print;
aligning the first and second direction images to identify an overlapping and a non-overlapping area of the aligned direction images;
comparing block direction between the first and second direction images within the overlapping area;
performing a rationality analysis on the aligned direction images to at least determine whether one of the direction images and the non-overlapping area comprising the other direction image are from a different finger; and
generating a similarity score based on the block direction comparison and the rationality analysis, which indicates a measure of similarity between the search and file prints.

2. The method of claim 1, wherein the file print is a candidate print output from a minutiae matching process.

3. The method of claim 2, wherein the similarity score is combined with a minutiae matching score output from the minutiae matching process and resulting from comparing minutiae from the file print with minutiae from the search print.

4. The method of claim 1, wherein the first and second direction images are aligned based on at least one of mated minutiae, cores, and deltas.

5. The method of claim 1, wherein comparing block direction between the first and second direction images comprises determining at least one of:
at least one parameter that is calculated based on a first number of blocks within the overlapping area each having a quality that exceeds a quality threshold and a direction difference that exceeds a direction difference threshold;
at least one parameter that is calculated based on a second number of blocks at a boundary of the overlapping area each having a quality that exceeds a quality threshold and a direction difference that exceeds a direction difference threshold; and
at least one measure of direction difference within the overlapping area.

6. The method of claim 5, wherein:
the at least one parameter that is calculated based on the first number of blocks comprises f1=Nq/Nd and f2=Nq/N, wherein N is a total number of blocks within the overlapping area, Nd is a portion of the N blocks having a quality that exceeds the quality threshold, and Nq is a portion of the Nd blocks having a direction difference that exceeds the direction difference threshold;
the at least one measure of direction difference within the overlapping area comprises f3=Σ{wi(qi)abs{Dsi−Dfi}, i=0 to N}/N and f4=(Σ{di−f3}²)/N, wherein Dsi−Dfi is the direction difference at block i, wi(qi) is a weighted function of a quality measure at block i, and di=wi(qi)abs{Dsi−Dfi}; and
the at least one parameter that is calculated based on the second number of blocks comprises f5=Nqb/Ndb and f6=Nqb/Nb, wherein Nb is a total number of blocks at the boundary of the overlapping area, Ndb is a portion of the Nb blocks having a quality that exceeds the quality threshold, and Nqb is a portion of the Ndb blocks having a direction difference that exceeds the direction difference threshold.

7. The method of claim 6, wherein generating the similarity score comprises modifying a first similarity score by a decision function f(f1, f2, f3, f4, f5 and f6).

8. The method of claim 7, wherein f(f1, f2, f3, f4, f5 and f6) is selected to adjust a non-matching distribution curve to minimize an overlap area between the non-matching distribution curve and a matching distribution curve.

9. The method of claim 1, wherein performing the rationality analysis comprises at least one of:
at a zone of horizontal rows across the aligned direction images, detecting at least one of whether a convex upward pattern exists in both the one of the direction images and in the non-overlapping area comprising the other direction image, and detecting whether a concave pattern exists in both the one of the direction images and in the non-overlapping area comprising the other direction image; and
at a zone of vertical columns down the aligned direction images, detecting at least one of whether a convex leftward pattern exists in both the one of the direction images and in the non-overlapping area comprising the other direction image, and detecting whether a convex rightward pattern exists in both the one of the direction images and in the non-overlapping area comprising the other direction image.

10. The method of claim 9, wherein performing the rationality analysis further comprises quantizing direction values into at least a / direction and a \ direction, and scanning rows and columns in the aligned direction images to detect the existence of the convex upward, concave, convex leftward and convex rightward patterns by detecting at least one of whether there is a direction change from the / direction to the \ direction and whether there is a direction change from the \ direction to the / direction.

11. The method of claim 9, wherein performing the rationality analysis further comprises identifying traced direction pseudo-ridge crossings within at least one of the zone of horizontal rows and the zone of vertical columns to detect the existence of the convex upward, concave, convex leftward and convex rightward patterns.

12. The method of claim 9, wherein the zone of horizontal rows comprises a plurality of adjacent rows in the aligned direction images, and the zone of vertical columns comprises a plurality of adjacent columns in the aligned direction images.

13. A print identification system comprising:
an interface receiving a search print record comprising at least a first direction image of a search print and a file print record comprising at least a second direction image of a file print; and
a processing device,
aligning the first and second direction images to identify an overlapping and a non-overlapping area of the aligned direction images;
comparing block direction between the first and second direction images within the overlapping area;
performing a rationality analysis on the aligned direction images to at least determine whether one of the direction images and the non-overlapping area comprising the other direction image are from a different finger; and
generating a similarity score based on the block direction comparison and the rationality analysis, which indicates a measure of similarity between the search and file prints.

14. The print identification system of claim 13, wherein the system is an Automatic Fingerprint Identification System (AFIS).

15. A computer-readable storage medium having computer readable code stored thereon for programming a computer to perform a method upon receiving a search print record comprising at least a first direction image of a search print and a file print record comprising at least a second direction image of a file print, the method comprising:
aligning the first and second direction images to identify an overlapping and a non-overlapping area of the aligned direction images;
comparing block direction between the first and second direction images within the overlapping area;
performing a rationality analysis on the aligned direction images to at least determine whether one of the direction images and the non-overlapping area comprising the other direction image are from a different finger; and
generating a similarity score based on the block direction comparison and the rationality analysis, which indicates a measure of similarity between the search and file prints.

16. The computer-readable storage medium of claim 15, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
